(19) United States
(12) Patent Application Publication
(10) Pub. No.: US 2024/0372585 A1
(43) Pub. Date: Nov. 7, 2024

(54) MULTI-DATA STREAM AND MULTI-BEAM BEAMFORMING IN A WIRELESS COMMUNICATIONS SYSTEM (WCS)

(71) Applicant: CORNING RESEARCH & DEVELOPMENT CORPORATION, Corning, NY (US)

(72) Inventors: Yury Abramov, Rosh HaAin (IL); Moshe Daniel, Gedera (IL); Benjamin Imanilov, Hod haSharon (IL); Roi Yosy Ziv, Ramat-Gan (IL)

(21) Appl. No.: 18/143,633

(22) Filed: May 5, 2023

(51) Int. Cl. H04B 7/06

(52) U.S. Cl. CPC H04B 7/0617; H04B 7/0682

(57) ABSTRACT

Multi-data stream and multi-beam beamforming in a wireless communications system (WCS) is disclosed. In the WCS, a wireless node(s) is configured to simultaneously emit multiple radio frequency (RF) beams in multiple intended directions. In this regard, in embodiments disclosed herein, the wireless node(s) is configured to include a beamforming circuit(s), which is configured to process multiple data streams to generate multiple processed streams each bearing the multiple data streams, and an antenna array(s) configured to simultaneously radiate the multiple processed streams to thereby form the multiple RF beams. Specifically, the beamforming circuit(s) is configured to generate each of the processed streams with predefined phase and amplitude to thereby cause the RF beams to be simultaneously formed in multiple elevations and/or azimuth angles. Moreover, the beamforming circuit(s) can be configured to include a lesser number of hardware than conventional beamforming circuits to help reduce cost and power consumption of the wireless node(s).

### BACKGROUND

The disclosure relates generally to simultaneous beamforming with multiple data streams and in multiple beams in a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

The WCS 100 may be configured to operate as a 5G and/or a 5G-NR communications system. In this regard, the radio node 102 can function as a 5G or 5G-NR base station (a.k.a. eNodeB) to service the wireless client devices 106(1)-106(W). Notably, the 5G or 5G-NR wireless communications system may be implemented based on a millimeter-wave (mmWave) spectrum that can make the communications signals 110(1)-110(N) more susceptible to propagation loss and/or interference. As such, it is desirable to radiate the RF beams 120(1)-120(N) based on a desirable number of RF beams to help mitigate signal propagation loss and/or interference. Moreover, it is desirable to configure the radio node 102 to provide adequate coverage in the 5G and/or 5G-NR communications system at minimum possible hardware and/or operation cost.

### SUMMARY

Embodiments disclosed herein include multi-data stream and multi-beam beamforming in a wireless communications system (WCS). In the WCS, a wireless node(s) is configured to simultaneously emit multiple radio frequency (RF) beams in multiple intended directions. In this regard, in embodiments disclosed herein, the wireless node(s) is configured to include a beamforming circuit(s), which is configured to process multiple data streams to generate multiple processed streams each bearing the multiple data streams, and an antenna array(s) configured to simultaneously radiate the multiple processed streams to thereby form the multiple RF beams. Specifically, the beamforming circuit(s) is configured to generate each of the processed streams with predefined phase and amplitude to thereby cause the RF beams to be simultaneously formed in multiple elevations and/or azimuth angles. Moreover, the beamforming circuit(s) can be configured to include a lesser number of hardware (e.g., digital-to-analog converter, controller, etc.) than conventional beamforming circuits to help reduce cost and power consumption of the wireless node(s).

One exemplary embodiment of the disclosure relates to a beamforming system. The beamforming system includes an antenna array. The antenna array includes a plurality of antenna elements organized in a first number of rows and a second number of columns. The first number of rows is greater than or equal to four rows. The beamforming system also includes a beamforming circuit. The beamforming circuit is configured to generate at least four processed streams each comprising a pair of data streams and processed to have a respective one of at least four phases and a respective one of at least four amplitudes. The beamforming circuit is also configured to provide the at least four processed streams to at least four of the first number of rows based on a predetermined feeding pattern to thereby cause the antenna array to simultaneously radiate a plurality of RF beams each comprising the pair of data streams in a defined set of elevations.

An additional exemplary embodiment of the disclosure relates to a method for forming multi-data stream and multi-beam RF beams in a WCS. The method includes organizing a plurality of antenna elements in an antenna array in a first number of rows and a second number of columns. The first number of rows is greater than or equal to four rows. The method also includes generating at least four processed streams each comprising a pair of data streams and processed to have a respective one of at least four phases and a respective one of at least four amplitudes. The method also includes providing the at least four processed streams to at least four of the first number of rows based on a predetermined feeding pattern to thereby cause the antenna array to simultaneously radiate a plurality of RF beams each comprising the pair of data streams in a defined set of elevations.

An additional exemplary embodiment of the disclosure relates to a WCS. The WCS includes a distribution unit. The distribution unit is configured to distribute a plurality of data signals. The WCS also includes a plurality of wireless nodes. The plurality of wireless nodes is coupled to the distribution unit. Each of the plurality of wireless nodes includes a beamforming system. The beamforming system includes an antenna array. The antenna array includes a plurality of antenna elements organized in a first number of rows and a second number of columns. The first number of rows is greater than or equal to four rows. The beamforming system also includes a beamforming circuit. The beamforming circuit is configured to generate at least four processed streams each comprising a pair of data streams and processed to have a respective one of at least four phases and a respective one of at least four amplitudes. The beamforming circuit is also configured to provide the at least four processed streams to at least four of the first number of rows based on a predetermined feeding pattern to thereby cause the antenna array to simultaneously radiate a plurality of RF beams each comprising the pair of data streams in a defined set of elevations.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIG. 2A is a schematic diagram of a radio frequency (RF) beamforming system in a conventional configuration;

FIGS. 2B-2C are schematic diagrams helping to define elevation and azimuth angle for RF beams formed by the RF beamforming system of FIG. 2A;

FIGS. 2D-2F are schematic diagrams illustrating conventional configurations of the RF beamforming system of FIG. 2A;

FIG. 3 is a schematic diagram of an exemplary WCS that can be configured to support multi-data stream and multi-beam beamforming according to various embodiments of the present disclosure;

FIG. 4 is a schematic diagram of an exemplary beamforming system that can be provided in the WCS of FIG. 3 and configured to support multi-data stream and multi-beam beamforming;

FIG. 5 is a flowchart of an exemplary process whereby the beamforming system of FIG. 4 can support multi-data stream and multi-beam beamforming;

FIG. 6 is a schematic diagram of an exemplary beamforming circuit in the beamforming system of FIG. 4;

FIGS. 7A-7E are graphic diagrams illustrating various multi-beam and multi-azimuth beamforming scenarios supported by the beamforming circuit of FIG. 6;

FIG. 8 is a partial schematic cut-away diagram of an exemplary building infrastructure in a WCS, such as the WCS of FIG. 3 that includes the beamforming system of FIG. 4 to support multi-data stream and multi-beam beamforming;

FIG. 9 is a schematic diagram of an exemplary mobile telecommunications environment that can include the WCS of FIG. 3 that includes the beamforming system of FIG. 4 to support multi-data stream and multi-beam beamforming; and

FIG. 10 is a schematic diagram of a representation of an exemplary computer system that can be included in or interfaced with any of the components in the WCS of FIG. 3 and the beamforming system in FIG. 4 to support multi-data stream and multi-beam beamforming, wherein the exemplary computer system is configured to execute instructions from an exemplary computer-readable medium.

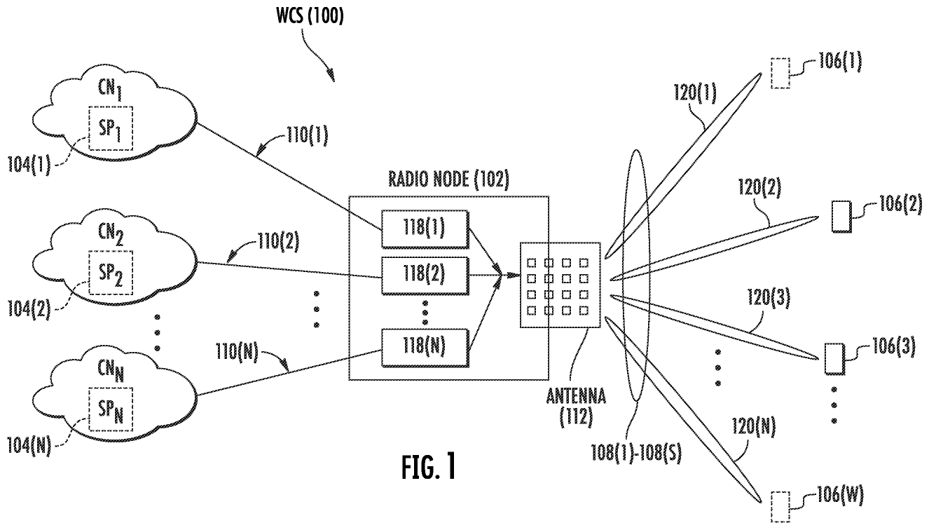

### DETAILED DESCRIPTION

Embodiments disclosed herein include multi-data stream and multi-beam beamforming in a wireless communications system (WCS). In the WCS, a wireless node(s) is configured to simultaneously emit multiple radio frequency (RF) beams in multiple intended directions. In this regard, in embodiments disclosed herein, the wireless node(s) is configured to include a beamforming circuit(s), which is configured to process multiple data streams to generate multiple processed streams each bearing the multiple data streams, and an antenna array(s) configured to simultaneously radiate the multiple processed streams to thereby form the multiple RF beams. Specifically, the beamforming circuit(s) is configured to generate each of the processed streams with predefined phase and amplitude to thereby cause the RF beams to be simultaneously formed in multiple elevations and/or azimuth angles. Moreover, the beamforming circuit(s) can be configured to include a lesser number of hardware (e.g., digital-to-analog converter, controller, etc.) than conventional beamforming circuits to help reduce cost and power consumption of the wireless node(s).

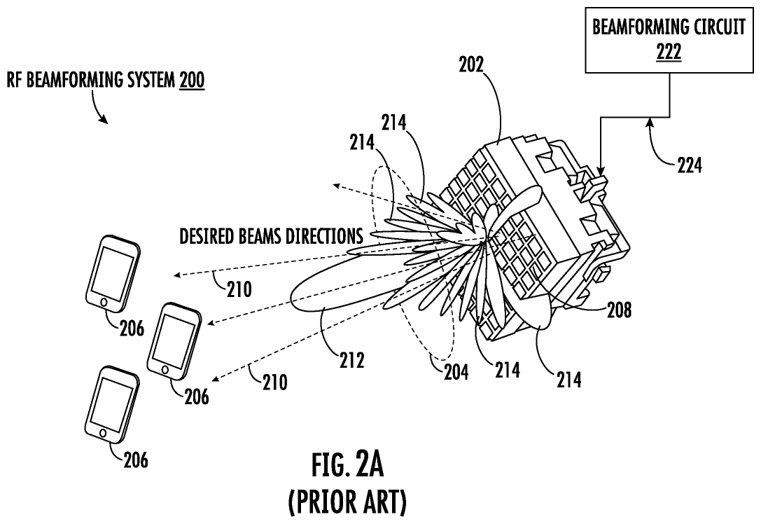

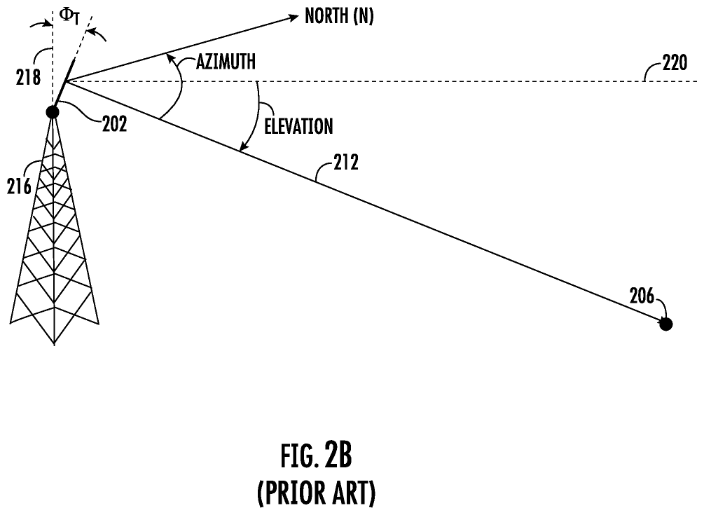

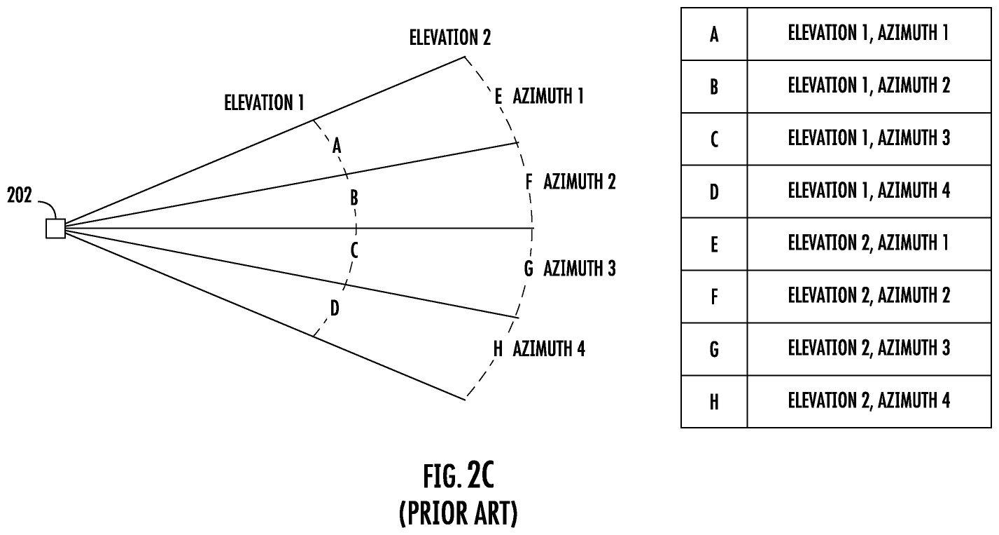

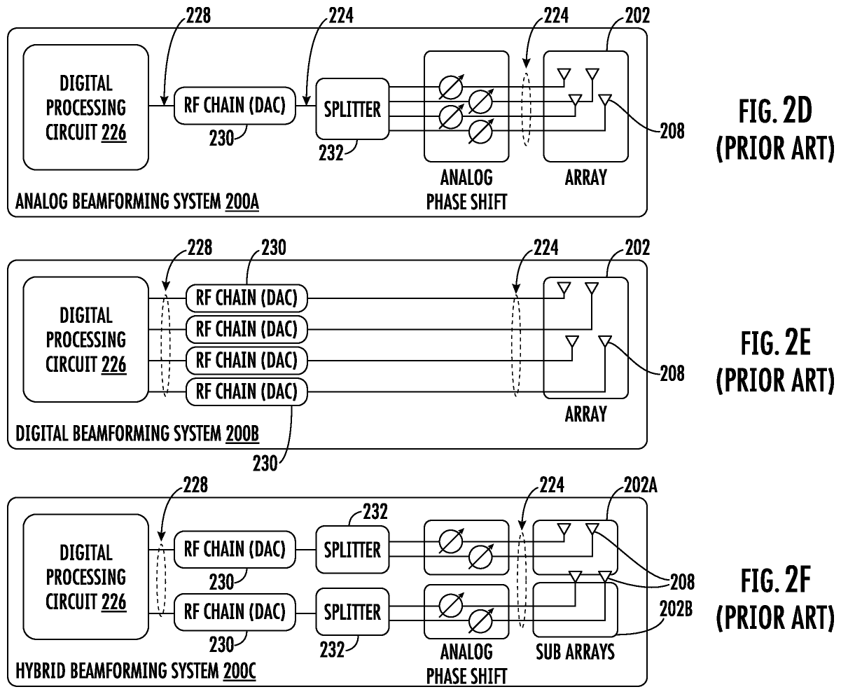

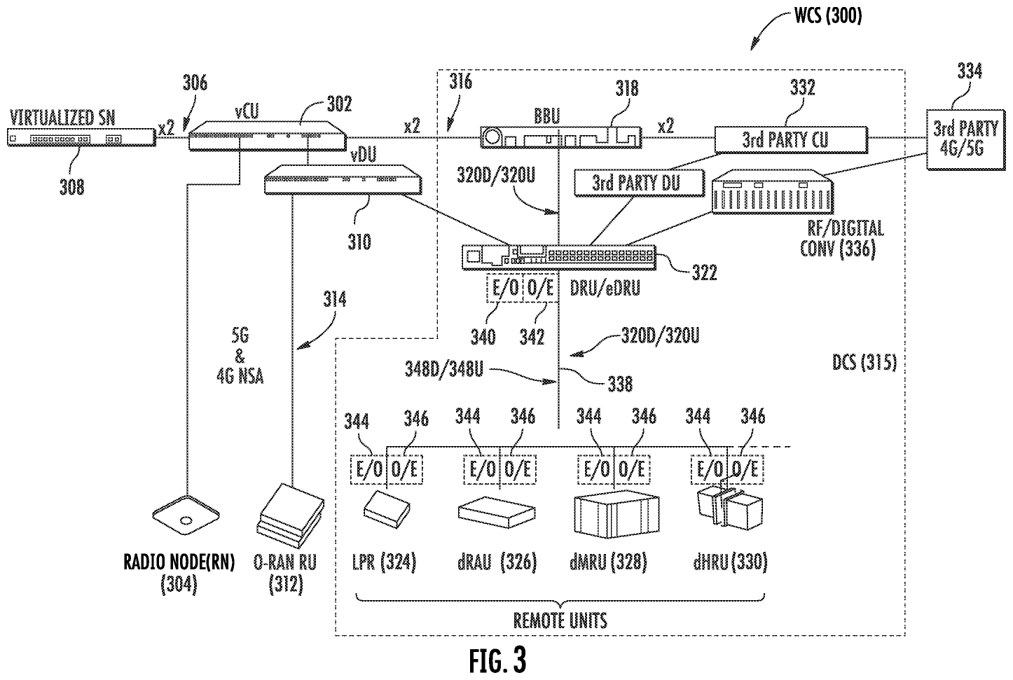

Before discussing a beamforming system of the present disclosure configured to support multi-data stream and multi-beam beamforming, starting at FIG. 3, a brief overview of a conventional beamforming system is first provided with reference to FIGS. 2A-2F to help explain some fundamental aspects related to RF beamforming and define some key terminologies used throughout the present disclosure.

In this regard, FIG. 2A is a schematic diagram of an RF beamforming system 200 wherein an antenna array 202 emits an RF beam(s) 204 toward one or more user devices 206. The antenna array 202 includes multiple antenna elements 208 that are typically separated from each other by a distance (a.k.a. “antenna spacing”). The RF beam(s) 204 emitted from the antenna elements 208 includes multiple beamforming signals (not shown). The beamforming signals are preprocessed based on a set of complex-valued coefficients, which is commonly known as a beamforming codeword, and/or further processed to provide phase and/or amplitude changes as needed. Specifically, multiplication of the beamforming codeword is realized by a combination of digital processing and through phase and/or amplitude control applied at an input of the antenna elements 208 to thereby maximize an array gain in a desired beam direction(s) 210. By applying the set of complex-valued coefficients to the beamforming signals, the multiple simultaneously emitted beamforming signals can form the RF beam(s) 204, which may be multiple RF beams each described by gain, intensity, power, and/or electric/magnetic field values versus elevation and azimuth directions. In this regard, it can be said that the RF beam(s) 204 is associated with, or defined by, a respective beamforming codeword. Accordingly, a list of different beamforming codewords, often referred to as a beamforming codebook, can define multiple different RF beams.

Notably, the RF beam(s) 204 often includes a main lobe 212, where radiated power is concentrated and close to a maximum radiated power, and one or more sidelobes 214 with lesser amounts of radiated power. Typically, a radiation direction of the main lobe 212 determines the desired beam direction(s) 210 of the RF beam(s) 204, and a beamwidth of the RF beam(s) 204 is defined by a set of the radiation directions 210 wherein the radiated power is not lower than 3 dB from the maximum radiated power.

Conventionally, the desired direction(s) 210 can be described by a combination of elevation and azimuth angle. FIGS. 2B-2C are schematic diagrams illustrating the elevation and the azimuth angle that can be used to describe the desired beam direction(s) 210 in the RF beamforming system 200 of FIG. 2A. Specifically, FIG. 2B represents a side view and FIG. 2C represents a top view of the antenna array 202. Common elements between FIGS. 2A-2C are shown therein with common element numbers and will not be re-described herein.

With reference to FIG. 2B, the antenna array 202 may be mounted on a radio tower 216 with a tilt angle ϕ_{T} relative to a vertical axis 218 perpendicular to a local horizon 220. The elevation of the main lobe 212, which defines the desired beam direction(s) 210, refers to a vertical angular distance between the antenna array 202 and the local horizon 220. The azimuth angle (referred interchangeably as “azimuth” hereinafter) of the main lobe 212, on the other hand, refers to the angle between North (N), measured clockwise around the local horizon 220, and a celestial body (e.g., sun or moon).

The elevation and the azimuth angle can thus be used to configure the RF beamforming system 200 of FIG. 2A to steer the RF beam(s) 204 toward the desired beam direction(s) 210. As shown in FIG. 2C, the antenna array 202 can be configured via different codewords to steer the RF beam(s) 204 towards coverage subareas A, B, C, D, E, F, G, H. As illustrated in the table, each of the coverage subareas A, B, C, D, E, F, G, H is defined by a respective one of elevations Elevation 1, Elevation 2 and a respective one of azimuth angles Azimuth 1, Azimuth 2, Azimuth 3, Azimuth 4.

With reference back to FIG. 2A, the RF beamforming system 200 typically includes a beamforming circuit 222 that preprocesses an RF signal 224 based on an appropriate codeword and provides the preprocessed RF signal 224 to all the antenna elements 208 to thereby form the RF beam(s) 204. FIGS. 2D-2F are schematic diagrams illustrating various configurations of the RF beamforming system 200 of FIG. 2A. Common elements between FIGS. 2A and 2D-2E are shown therein with common element numbers and will not be re-described herein.

FIG. 2D is a schematic diagram of an exemplary analog beamforming system 200A that can function as the RF beamforming system 200 of FIG. 2A. Herein, a digital processing circuit 226 is configured to preprocess a digital signal 228 based on an appropriate beamforming codeword(s), a single RF chain 230, which can include a digital-to-analog converter (DAC) and/or an analog-to-digital converter (ADC), is configured to convert the digital signal 228 into the RF signal 224, and a common RF splitter 232 will then split the RF signal 224 among the antenna elements 208. Given the single RF chain 230, the analog beamforming system 200A is typically unable to radiate the RF signal 224 with multiple data streams and in multiple elevations.

FIG. 2E is a schematic diagram of an exemplary digital beamforming system 200B that can function as the RF beamforming system 200 of FIG. 2A. In the digital beamforming system 200B, each of the antenna elements 208 has a dedicated RF chain/DAC/ADC 230. As a result, the digital beamforming system 200B can provide the most flexible beam control in terms of elevation and azimuth angle, but at the expense of higher cost and power consumption.

FIG. 2F is a schematic diagram of an exemplary hybrid beamforming system 200C that can function as the RF beamforming system 200 of FIG. 2A. As the name implies, the hybrid beamforming system 200C combines aspects of the analog beamforming system 200A of FIG. 2D and the digital beamforming system 200B of FIG. 2E. Herein, the antenna array 202 may be divided into sub arrays 202A, 202B, each to be controlled by a respective RF chain/DAC/ADC 230 and a respective splitter 232. Although the hybrid beamforming system 200C can provide flexible beam control in the azimuth angle at a lower cost compared to the digital beamforming system 200B, the hybrid beamforming system 200C may not be capable of radiating the RF signal 224 simultaneously in multiple elevations. As such, it is desirable to adapt the hybrid beamforming system 200C to support simultaneous multi-elevation, multi- azimuth beamforming.

In this regard, FIG. 3 is a schematic diagram of an exemplary WCS 300 that can be configured according to various embodiments of the present disclosure to support multi-data stream and multi-beam. The WCS 300 supports both legacy 4G LTE, 4G/5G non-standalone (NSA), and 5G standalone communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to a radio node 304 (e.g., 5G or 5G-NR gNB). Despite that only one radio node 304 is shown in FIG. 3, it should be appreciated that the WCS 300 can be configured to include additional numbers of the radio node 304, as needed.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a wireless node refers generally to a wireless communication circuit including at least a processing circuit, a memory circuit, and an antenna circuit, and can be configured to process, transmit, and receive a wireless communications signal. In this regard, any of the radio node 304, the O-RAN RN 312, the LPR 324, the dRAU 326, the dMRU 328, and the dHRU 330 can function as a wireless node to reduce power consumption associated with RF beam sidelobe suppression based on embodiments disclosed herein. As described in detail below, the wireless node in the WCS 300 can include a beamforming system configured according to embodiments of the present disclosure to support simultaneous multi-data stream and multi-beam beamforming.

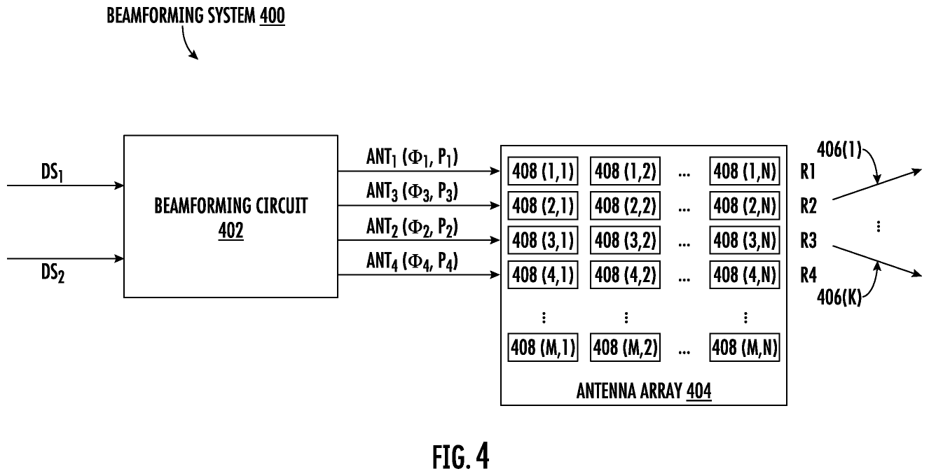

FIG. 4 is a schematic diagram of an exemplary beamforming system 400 that can be provided in the wireless node in the WCS 300 of FIG. 3 to support simultaneous multi-data stream and multi-beam beamforming. Common elements between FIGS. 3 and 4 are shown therein with common element numbers and will not be re-described herein. As described below, the beamforming system 400 is different from and advantageous over the analog beamforming system 200A, the digital beamforming system 200B, and the hybrid beamforming system 200C because the beamforming system 400 can support simultaneous multi-stream (a.k.a. “multi-data stream”) and multi-beam beamforming at lower cost (up to 50% reduction), lower complexity (up to 25% reduction), and lower power consumption (up to 20% reduction) compared to the analog beamforming system 200A, the digital beamforming system 200B, and the hybrid beamforming system 200C.

The beamforming system 400 includes a beamforming circuit 402 and an antenna array 404. However, it should be appreciated that the beamforming system 400 can be configured to include additional beamforming circuits and additional antenna arrays without changing operating principles of the beamforming system 400 described herein. Herein, the beamforming circuit 402 is configured to receive at least a pair of data streams DS₁, DS₂ and preprocess the data streams DS₁, DS₂ to thereby cause the antenna array 404 to simultaneously radiate a plurality of RF beams 406(1)-406(K), each bearing the data streams DS₁, DS₂, in a defined set of elevations.

The antenna array 404 includes a plurality of antenna elements 408(1,1)-408(M, N) that are organized into a first number (M) of rows and a second number (N) of columns. In context of the present disclosure, the antenna elements 408(1,1)-408(M, N) are configured to provide elevation control instead of azimuth control. As such, the antenna elements 408(1,1)-408(M, N) are separated from one another by an antenna spacing that is either less than one-half wavelength (<½λ) or greater than one-half wavelength (>½λ) but does not equal one-half wavelength (≠½λ). In a non-limiting example, the antenna spacing can be seven-tenth wavelength (0.7λ).

In context of the present disclosure, the first number (M) is greater than or equal to four (M≥4) and the second number (N) is greater than or equal to the first number (M) (N≥M). Preferably, the first number (M) is a multiple of four (M=4x, x=1, 2, 3, . . . ). However, it should be appreciated that the beamforming system 400 can still be configured according to embodiments disclosed here to support multi-data stream and multi-beam, beamforming even if the first number (M) is not a multiple of four. For example, if the antenna array 404 is configured to include six rows, the beamforming system 400 can still operate properly by idling any two of the six rows in the antenna array 404 or by controlling the two of the six rows in the antenna array 404 via parallel analog/digital/hybrid beamforming systems.

For the convenience of illustration and reference, the antenna array 404 is discussed herein based on a 4×8 configuration (a.k.a. M=4 and N=8) that includes the antenna elements 408(1,1)-408(4,8). Accordingly, the beamforming circuit 402 is configured to generate at least four processed streams ANT₁-ANT₄, each generated to include the data streams DS₁, DS₂ and preprocessed to have a respective one of multiple phases ϕ₁-ϕ₄ and, optionally a respective one of multiple amplitudes P₁-P₄. The phases ϕ₁-ϕ₄ and, optionally the amplitudes P₁-P₄ may be first processed digitally based on a predefined beamforming codeword(s) and subsequently processed in analog domain to thereby cause the antenna array 404 to simultaneously radiate the RF beams 406(1)-406(K) in the defined set of elevations.

As illustrated in equations (Eq. 1.1 and 1.2) below, the embodiments disclosed herein can replace phase shifters with signal inverters, which not only are simpler and more accurate than phase shifters, but also introduce less insertion losses and consume virtually less energy relative to the phase shifters. As such, the beamforming system 400 described herein is a more efficient form of hybrid beamforming system than the hybrid beamforming system 200C in FIG. 2F.

$$\begin{matrix}{C}_{4 \times 2}^{beams A \& B} = [ \begin{matrix}- 1 & - 1 \\ {e}^{- i \frac{π}{2}} & - {e}^{- i \frac{π}{2}} \\ 1 & 1 \\ - {e}^{- i \frac{π}{2}} & {e}^{- i \frac{π}{2}}\end{matrix} ] = [ \begin{matrix}{e}^{- i π} & {e}^{- i π} \\ {e}^{- i \frac{π}{2}} & {e}^{- i \frac{3 π}{2}} \\ {e}^{- i 0} & {e}^{- i 0} \\ {e}^{- i \frac{3 π}{2}} & {e}^{- i \frac{π}{2}}\end{matrix} ] & ( Eq . 1.1 ) \\ {C}_{4 \times 2}^{beams C \& D} = [ \begin{matrix}1 & 1 \\ 1 & - 1 \\ 1 & 1 \\ 1 & - 1\end{matrix} ] = [ \begin{matrix}{e}^{- i 0} & {e}^{- i 0} \\ {e}^{- i 0} & {e}^{- i π} \\ {e}^{- i 0} & {e}^{- i 0} \\ {e}^{- i 0} & {e}^{- i π}\end{matrix} ] & ( Eq . 1.2 )\end{matrix}$$

In the example of the 4×8 antenna array configuration, the beamforming circuit 402 is configured to provide the processed streams ANT₁-ANT₄ to at least four rows R1-R4 in the antenna array 404 based on a predetermined feeding pattern to thereby form the RF beams 406(1)-406(K) in the defined set of elevations. In an embodiment, the predetermined feeding pattern involves feeding the processed stream ANT₁ to row R1 (ANT₁→R1), feeding the processed stream ANT₂ to row R3 (ANT₂→R3), feeding the processed stream ANT₃ to row R2 (ANT₃→R2), and feeding the processed stream ANT₄ to row R4 (ANT₄→R4).

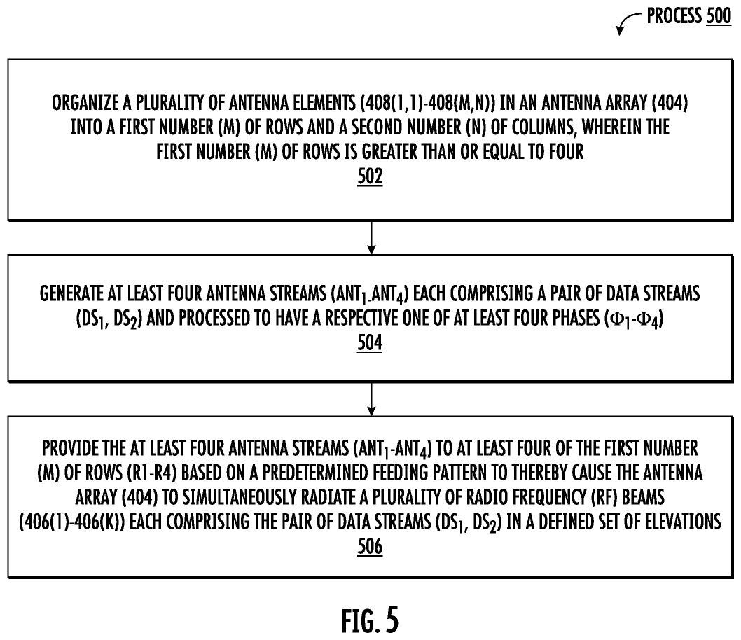

The beamforming system 400 may be configured to support multi-data stream and multi-beam beamforming based on a process. In this regard, FIG. 5 is a flowchart of an exemplary process 500 whereby the beamforming system 400 of FIG. 4 can support multi-data stream and multi-beam beamforming.

Herein, the antenna elements 408(1,1)-408(M, N) in the antenna array 404 is first organized into the first number (M) of rows and the second number (N) of columns (block 502). Herein, the first number (M) of rows is greater than or equal to four (M≥4).

In the example of 4×8 configuration described above, the beamforming circuit 402 is configured to generate the processed streams ANT₁-ANT₄ each generated to include the data streams DS₁, DS₂ and processed to have a respective one of the phases ϕ₁-ϕ₄ (block 504). The beamforming circuit 402 is further configured to provide the processed streams ANT₁-ANT₄ to the rows R1-R4 based on the predetermined feeding pattern to thereby cause the antenna array 404 to simultaneously radiate the RF beams 406(1)-406(K), each including the data streams DS₁, DS₂, in the defined set of elevations (block 506).

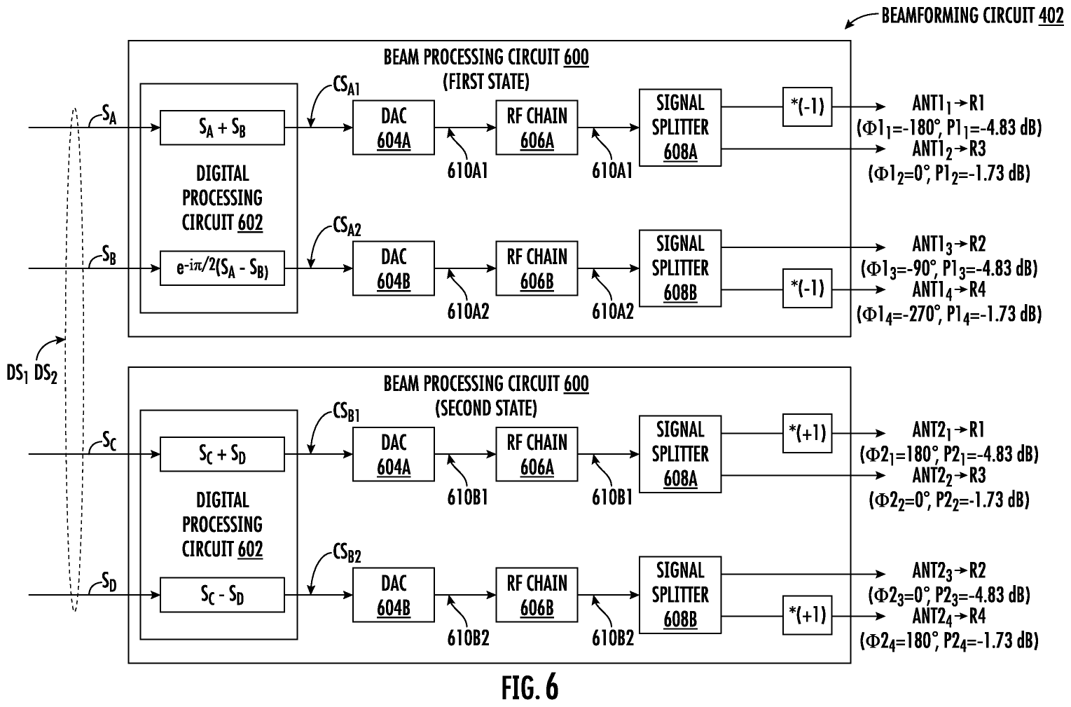

FIG. 6 is a schematic diagram providing an exemplary illustration of the beamforming circuit 402 in the beamforming system of FIG. 4. Common elements between FIGS. 4 and 6 are shown therein with common element numbers and will not be re-described herein. Notably, although the beamforming circuit 402 is described with respect to a downlink transmission, it should be appreciated that the beamforming circuit 402 can also be configured according to aspects described herein for uplink transmission and/or reception.

In an embodiment, the beamforming circuit 402 includes a beam processing circuit 600. The beam processing circuit 600 includes a digital processing circuit 602, a pair of first DACs 604A, 604B, a pair of RF chains 606A, 606B, and a pair of signal splitters 608A, 608B. In an embodiment, the beam processing circuit 600 can be configured to toggle between a first state and a second state based on time-division.

In the first state, the digital processing circuit 602 receives a first pair of data streams S_{A}, S_{B}. Herein, the data streams S_{A}, S_{B} may be equated with the data streams DS₁, DS₂ discussed earlier. The digital processing circuit 602 is configured to preprocess the data streams S_{A}, S_{B} (e.g., based on an appropriate beamforming codeword) to generate a pair of first composite data signals CS_{A1}, CS_{A2}. According to an embodiment of the present disclosure, the first composite data signals CS_{A1}, CS_{A2} are generated in accordance with equations (Eq. 2.1 and 2.6) below.

$$\begin{matrix}{CS}_{A 1} = {S}_{A} + {B}_{B} = {e}^{- i 0} \times {S}_{A} + {e}^{- i 0} \times {S}_{A} & ( Eq . 2.1 ) \\ {CS}_{A 2} = {e}^{- i π / 2} ( {S}_{A} - {S}_{B} ) = {e}^{- i \frac{π}{2}} \times {S}_{A} + {e}^{- i \frac{3 π}{2}} \times {S}_{A} & ( Eq . 2.2 ) \\ {R}_{1} = {e}^{- i π} \times {S}_{A} + {e}^{- i π} \times {S}_{A} & ( Eq . 2.3 ) \\ {R}_{3} = {e}^{- i 0} \times {S}_{A} + {e}^{- i 0} \times {S}_{A} & ( Eq . 2.4 ) \\ {R}_{2} = {e}^{- i \frac{π}{2}} \times {S}_{A} + {e}^{- i \frac{3 π}{2}} \times {S}_{A} & ( Eq . 2.5 ) \\ {R}_{4} = {e}^{- i \frac{π}{2}} \times {S}_{A} + {e}^{- i \frac{π}{2}} \times {S}_{A} & ( Eq . 2.6 )\end{matrix}$$

The DACs 604A, 604B are configured to convert the first composite data signals CS_{A1}, CS_{A2} into a pair of first RF signals 610A1, 610A2, respectively. Understandably, each of the first RF signals 610A1, 610A2 also includes the data streams S_{A}, S_{B}. The RF chains 606A, 606B may each include, for example, power amplifiers, RF filters, and/or RF switches and may be configured to further process a respective one of the first RF signals 610A1, 610A2. The signal splitters 608A, 608B are configured to split the first RF signals 610A1, 610A2 into four first processed streams ANT1₁-ANT1₄. More specifically, the signal splitter 608A splits the first RF signal 610A1 to generate the first processed streams ANT1₁, ANT1₂ and the signal splitter 608B splits the first RF signal 610A2 to generate the first processed streams ANT1₃, ANT1₄. Notably, the first processed streams ANT1₁ and ANT1₄ are each phase shifted by a one hundred eighty degree) (−180°). In contrast, the first processed streams ANT1₂ and ANT1₃ are not phase shifted.

As a result, the first processed stream ANT1₁ is associated with a respective phase ϕ1₁ of negative one hundred eighty degrees (ϕ1₁=−180°) and, optionally a respective amplitude P1₁ of −4.83 dB (P1₁=−4.83 dB), the first processed stream ANT1₂ is associated with a respective phase ϕ1₂ of zero degree (ϕ1₂=0°) and, optionally a respective amplitude P1₂ of −1.73 dB (P1₂=−1.73 dB), the first processed stream ANT1₃ is associated with a respective phase ϕ1₃ of negative ninety degrees (ϕ1₃=90°) and, optionally a respective amplitude P1₃ of −4.83 dB (P1₁=−4.83 dB), and the first processed stream ANT1₄ is associated with a respective phase ϕ1₄ of negative two hundred seventy degrees (ϕ1₄=270°) and, optionally a respective amplitude P1₄ of −1.73 dB (P1₄=−1.73 dB). According to the predetermined feeding pattern described in FIG. 4, the first processed stream ANT1₁ is fed to row R1 in the 4×8 antenna array 404 in FIG. 4 (ANT1₁→R1), the first processed stream ANT1₂ is fed to row R3 in the 4×8 antenna array 404 (ANT1₂→R3), the first processed stream ANT1₃ is fed to row R2 in the 4×8 antenna array 404 (ANT1₃→R2), and the first processed stream ANT1₄ is fed to row R4 in the 4×8 antenna array 404 (ANT1₄→R4).

In the second state, the digital processing circuit 602 receives a second pair of data streams S_{C}, S_{D}. Herein, the data streams S_{D}, S_{D} may be equated with the data streams DS₁, DS₂ discussed earlier. The digital processing circuit 602 is configured to preprocess the data streams S_{C}, S_{D} (e.g., based on an appropriate beamforming codeword) to generate a pair of second composite data signals CS_{B1}, CS_{B2}. According to an embodiment of the present disclosure, the second composite data signals CS_{B1}, CS_{B2} are generated in accordance with equations (Eq. 3.1 and 3.6) below.

$$\begin{matrix}{CS}_{B 1} = {S}_{C} + {S}_{D} = {e}^{- i 0} \times {S}_{C} + {e}^{- i 0} \times {S}_{D} & ( Eq . 3.1 ) \\ {CS}_{B 2} = ( {S}_{C} - {S}_{D} ) = {e}^{- i 0} \times {S}_{C} + {e}^{- i π} \times {S}_{D} & ( Eq . 3.2 ) \\ {R}_{1} = {e}^{- i 0} \times {S}_{C} + {e}^{- i 0} \times {S}_{D} & ( Eq . 3.3 ) \\ {R}_{3} = {e}^{- i 0} \times {S}_{C} + {e}^{- i 0} \times {S}_{D} & ( Eq . 3.4 ) \\ {R}_{2} = {e}^{- i 0} \times {S}_{C} + {e}^{- i 0} \times {S}_{D} & ( Eq . 3.5 ) \\ {R}_{4} = {e}^{- i 0} \times {S}_{C} + {e}^{- i π} \times {S}_{D} & ( Eq . 3.6 )\end{matrix}$$

The DACs 604A, 604B are configured to convert the second composite data signals CS_{B1}, CS_{B2} into a pair of second RF signals 610B1, 610B2, respectively. Understandably, each of the second RF signals 610B1, 610B2 also includes the data streams S_{C}, S_{D}. The RF chains 606A, 606B may be configured to further process a respective one of the second RF signals 610B1, 610B2. The signal splitters 608A, 608B are configured to split the second RF signals 610B1, 610B2 into four second processed streams ANT2₁-ANT2₄. More specifically, the signal splitter 608A splits the second RF signal 610B1 to generate the second processed streams ANT2₁, ANT2₂ and the signal splitter 608B splits the second RF signal 610B2 to generate the second processed streams ANT2₃, ANT2₄. Notably, the second processed streams ANT2₁ and ANT2₄ are each phase shifted by a positive one hundred eighty degree (180°). In contrast, the second processed streams ANT2₂ and ANT2₃ are not phase shifted.

As a result, the second processed stream ANT2₁ is associated with a respective phase ϕ2₁ of positive one hundred eighty degrees (π2₁=180°) and, optionally a respective amplitude P2₁ of −4.83 dB (P2₁=−4.83 dB), the second processed stream ANT2₂ is associated with a respective phase ϕ2₂ of zero degree (ϕ2₂=0°) and, optionally a respective amplitude P2₂ of −1.73 dB (P2₂=−1.73 dB), the second processed stream ANT2₃ is associated with a respective phase ϕ2₃ of zero degree (ϕ2₃=0°) and, optionally a respective amplitude P2₃ of −4.83 dB (P2₁=−4.83 dB), and the second processed stream ANT2₄ is associated with a respective phase ϕ2₄ of positive one hundred eighty degrees (ϕ2₄=180°) and, optionally a respective amplitude P2₄ of −1.73 dB (P2₄=−1.73 dB). According to the predetermined feeding pattern described in FIG. 4, the second processed stream ANT2₁ is fed to row R1 in the 4×8 antenna array 404 in FIG. 4 (ANT2₁→R1), the second processed stream ANT2₂ is fed to row R3 in the 4×8 antenna array 404 (ANT2₂→R3), the second processed stream ANT2₃ is fed to row R2 in the 4×8 antenna array 404 (ANT2₃→R2), and the second processed stream ANT2₄ is fed to row R4 in the 4×8 antenna array 404 (ANT2₄→R4).

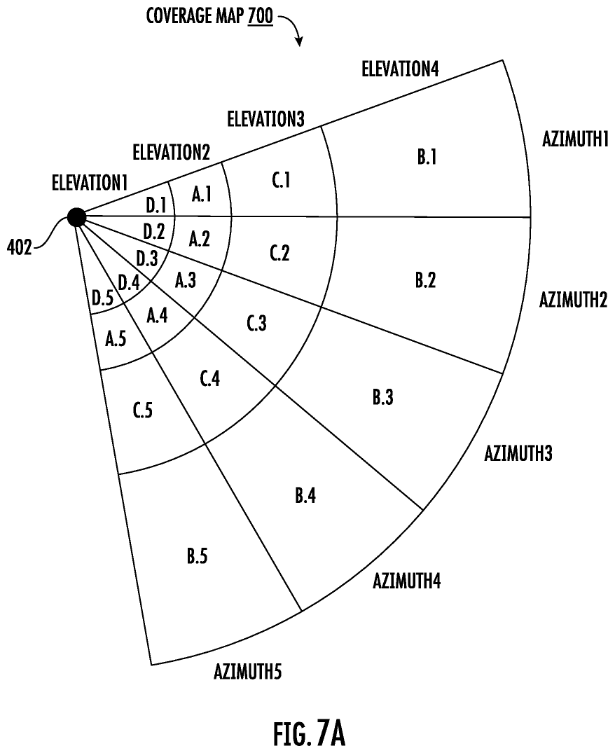

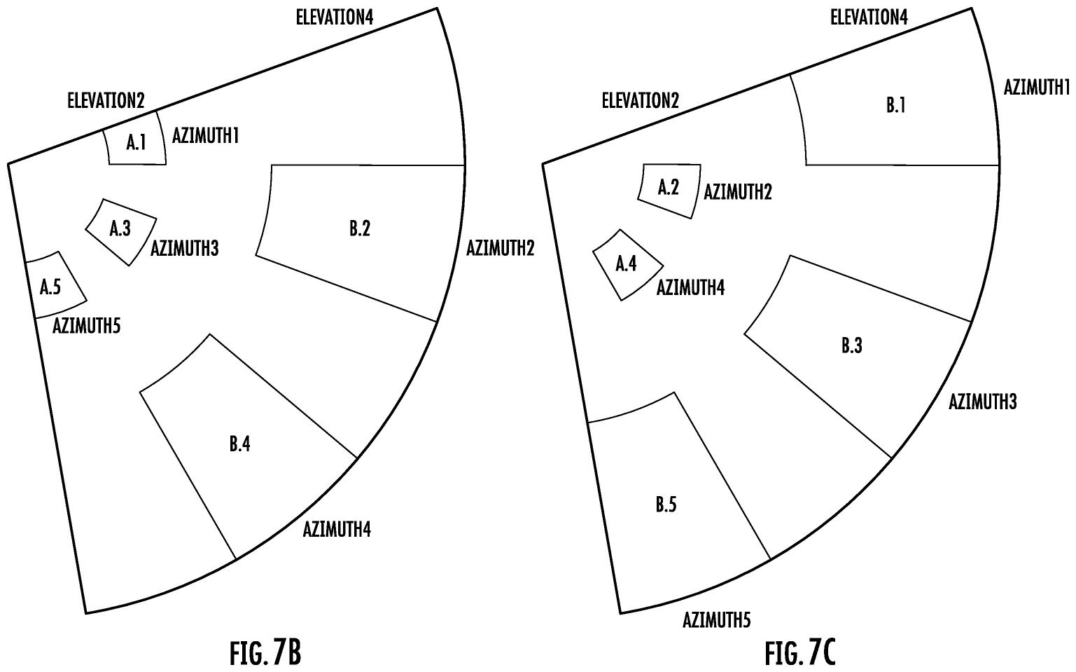

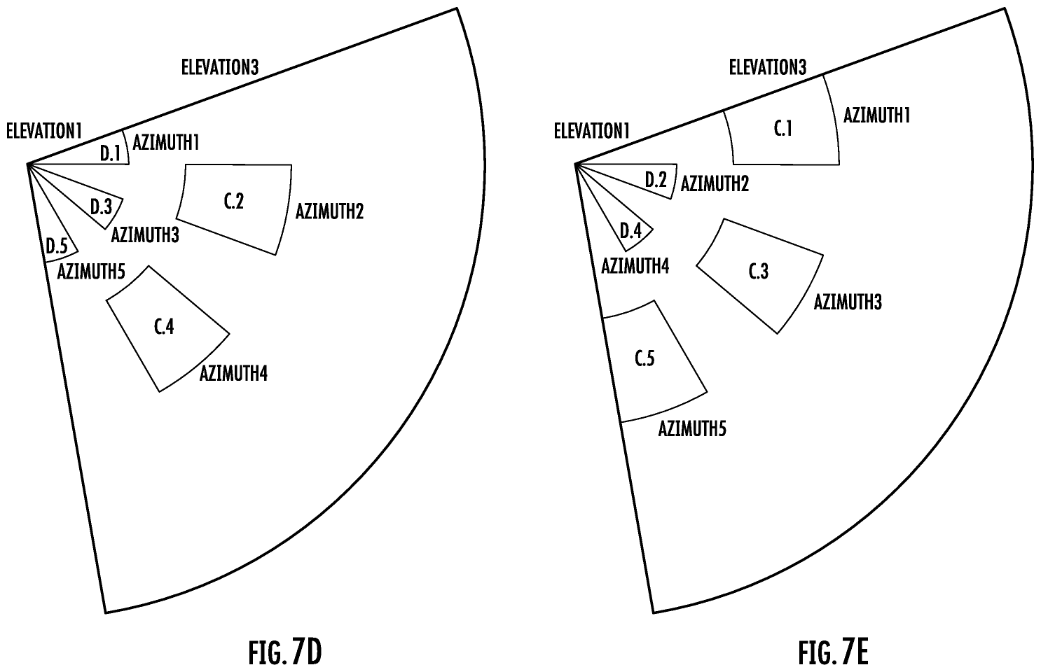

Notably, the beamforming circuit 402 may be configured to include the beam processing circuit 600. In case the beamforming circuit 402 is configured to include the beam processing circuit 600, the beam processing circuit 600 will operate alternately based on time-division. As discussed in FIGS. 7A-7E, it is possible to enable more flexible coverage configuration by operating the beam processing circuit 600 based on time-division.

The table below illustrates coefficients for phase shifting of a specific beam. In any column of the table, the same pattern of phases differences is applied between 4 elements in a respective column, which defines elevation control on the beam. In any row of the table, the same pattern of phases differences is applied between 8 elements in each of the rows, which in turn defines azimuth angle on the beam.

| | | | | | | | |
|---|---|---|---|---|---|---|---|
| e⁻ⁱ⁰ | e^{-i(Δ}^{₁}^{^{AZ}}⁾ | e^{-i(Δ}^{₂}^{^{AZ}}⁾ | e^{-i(Δ}^{₃}^{^{AZ}}⁾ | e^{-i(Δ}^{₄}^{^{AZ}}⁾ | e^{-i(Δ}^{₅}^{^{AZ}}⁾ | e^{-i(Δ}^{₆}^{^{AZ}}⁾ | e^{-i(Δ}^{₇}^{^{AZ}}⁾ |
| e^{-i(Δ}^{₁}^{^{EL}}⁾ | e^{-i(Δ}^{₁}^{^{EL}}^{+Δ}^{₁}^{^{AZ}}⁾ | e^{-i(Δ}^{₁}^{^{EL}}^{+Δ}^{₂}^{^{AZ}}⁾ | e^{-i(Δ}^{₁}^{^{EL}}^{+Δ}^{₃}^{^{AZ}}⁾ | e^{-i(Δ}^{₁}^{^{EL}}^{+Δ}^{₄}^{^{AZ}}⁾ | e^{-i(Δ}^{₁}^{^{EL}}^{+Δ}^{₅}^{^{AZ}}⁾ | e^{-i(Δ}^{₁}^{^{EL}}^{+Δ}^{₆}^{^{AZ}}⁾ | e^{-i(Δ}^{₁}^{^{EL}}^{+Δ}^{₇}^{^{AZ}}⁾ |
| e^{-i(Δ}^{₂}^{^{EL}}⁾ | e^{-i(Δ}^{₂}^{^{EL}}^{+Δ}^{₁}^{^{AZ}}⁾ | e^{-i(Δ}^{₂}^{^{EL}}^{+Δ}^{₂}^{^{AZ}}⁾ | e^{-i(Δ}^{₂}^{^{EL}}^{+Δ}^{₃}^{^{AZ}}⁾ | e^{-i(Δ}^{₂}^{^{EL}}^{+Δ}^{₄}^{^{AZ}}⁾ | e^{-i(Δ}^{₂}^{^{EL}}^{+Δ}^{₅}^{^{AZ}}⁾ | e^{-i(Δ}^{₂}^{^{EL}}^{+Δ}^{₆}^{^{AZ}}⁾ | e^{-i(Δ}^{₂}^{^{EL}}^{+Δ}^{₇}^{^{AZ}}⁾ |
| e^{-i(Δ}^{₃}^{^{EL}}⁾ | e^{-i(Δ}^{₃}^{^{EL}}^{+Δ}^{₁}^{^{AZ}}⁾ | e^{-i(Δ}^{₃}^{^{EL}}^{+Δ}^{₂}^{^{AZ}}⁾ | e^{-i(Δ}^{₃}^{^{EL}}^{+Δ}^{₃}^{^{AZ}}⁾ | e^{-i(Δ}^{₃}^{^{EL}}^{+Δ}^{₄}^{^{AZ}}⁾ | e^{-i(Δ}^{₃}^{^{EL}}^{+Δ}^{₅}^{^{AZ}}⁾ | e^{-i(Δ}^{₃}^{^{EL}}^{+Δ}^{₆}^{^{AZ}}⁾ | e^{-i(Δ}^{₃}^{^{EL}}^{+Δ}^{₇}^{^{AZ}}⁾ |

FIGS. 7A-7E are graphic diagrams illustrating various multi-elevation and multi-azimuth beamforming scenarios supported by the beamforming circuit 402 of FIG. 6. Common elements between FIGS. 6 and 7A-7E are shown therein with common element numbers and will not be re-described herein. As described in FIG. 6, the phases applied to a column in the antenna array 404 control the elevations of paired beams. Without restriction, the general steering control for azimuth may have a similar phase pattern. However, it should be appreciated that the method described herein can be applied to rows as well as columns.

With reference to FIG. 7A, an example of 5 possible directions in azimuth and 4 possible directions in elevation are illustrated. Herein, a total of 20 beams are illustrated to cover all together 20 subareas of a total coverage area. However, neighboring beams may interfere on the edges of neighboring coverage subareas. To avoid such interference, it is possible to configure the beamforming circuit 402 of FIG. 6 to transmit simultaneously a maximum of 5 beams that belong to a group of non-interfering beams as illustrated in FIGS. 7B-7F. With respect to elevation, the RF beams covering the subareas A.1-A.5 and B.1-B.5 are paired. Similarly, the RF beams covering the subareas C.1-C.5 and D.1-D.5 are also paired. As for azimuth, all 5 possible azimuth options are used, but distributed among elevation options to avoid interference (i.e., to avoid simultaneous transmission of neighboring coverage sub-area beams).

Specifically, FIG. 7A illustrates an exemplary coverage map 700 that can be divided into four (4) elevations Elevation1-Elevation4 and five (5) azimuth angles Azimuth1-Azimuth5. The elevations Elevation1-Elevation4 can be further divided into a first set of elevations and a second set of elevations. In an embodiment, the first set of elevations includes Elevation2 and Elevation4, and the second set of elevations includes Elevation1 and Elevation3. The azimuth angles Azimuth1-Azimuth5 in each of the elevations Elevation1-Elevation4 can also be further divided into a first set of azimuth angles and a second set of azimuth angles. In an embodiment, the first set of azimuth angles includes azimuth angles Azimuth1, Azimuth3, Azimuth5, and the second set of azimuth angles includes azimuth angles Azimuth2, Azimuth4. Notably, to support the coverage map 700 with a 4×8 antenna array, it is necessary to employ 8 of the beam processing circuits 600 of FIG. 6 from an elevation point of view, but with different phase offset for azimuth control as illustrated in the table above.

As further illustrated in FIGS. 7B-7E, it is possible to minimize intra-pair mutual interference and improve coverage throughout the coverage map 700 by interleaving the first set of azimuth angles and the second set of azimuth angles in each of the first set of elevations and the second set of elevations. Moreover, the antenna array 404 may be mounted with a fixed tilt (e.g., 23.8°), and for a specific height (e.g., 20 meters), to provide coverage throughout the coverage map 700.

With reference to FIG. 7B, the beam processing circuit 600 is configured to generate the first processed streams ANT1₁-ANT1₄ to cause the antenna array 404 to simultaneously radiate five (5) RF beams A.1, A.3, A.5, B.2, and B.4 in the first set of elevations Elevation2 and Elevation4. More specifically, the RF beams A.1, A.3, A.5 are radiated in the elevation Elevation2 and the azimuth angles Azimuth1, Azimuth3, Azimuth5, and the RF beams B.2, B.4 are radiated in the elevation Elevation4 and the azimuth angles Azimuth2, Azimuth4.

With reference to FIG. 7C, the beam processing circuit 600 is further configured to generate the first processed streams ANT1₁-ANT1₄ to cause the antenna array 404 to simultaneously radiate five (5) RF beams A.2, A.4, B.1, B.3, and B.5 in the first set of elevations Elevation2 and Elevation4. More specifically, the RF beams A.2, A.4 are radiated in the elevation Elevation2 and the azimuth angles Azimuth2, Azimuth4, and the RF beams B.1, B.3, B.5 are radiated in the elevation Elevation4 and the azimuth angles Azimuth1, Azimuth3, Azimuth5.

With reference to FIG. 7D, the beam processing circuit 600 is configured to generate the second processed streams ANT2₁-ANT2₄ to cause the antenna array 404 to simultaneously radiate five (5) RF beams D.1, D.3, D.5, C.2, and C.4 in the second set of elevations Elevation1 and Elevation3. More specifically, the RF beams D.1, D.3, D.5 are radiated in the elevation Elevation1 and the azimuth angles Azimuth1, Azimuth3, Azimuth5, and the RF beams C.2, C.4 are radiated in the elevation Elevation3 and the azimuth angles Azimuth2, Azimuth4.

With reference to FIG. 7E, the beam processing circuit 600 is further configured to generate the second processed streams ANT2₁-ANT2₄ to cause the antenna array 404 to simultaneously radiate five (5) RF beams D.2, D.4, C.1, C.3, and C.5 in the second set of elevations Elevation1 and Elevation3. More specifically, the RF beams D.2, D.4 are radiated in the elevation Elevation1 and the azimuth angles Azimuth2, Azimuth4, and the RF beams C.1, C.3, C.5 are radiated in the elevation Elevation3 and the azimuth angles Azimuth1, Azimuth3, Azimuth5.

With reference back to FIG. 6, to help reduce sidelobes, such as the sidelobes 214 illustrated in FIG. 2A, the signal splitters 608A, 608B may be asymmetrical splitters without attenuation to thereby allow the signal splitters 608A, 608B to utilize full power provided by the DACs 604A, 604B.

The beam processing circuit 600 may also use lossless low complexity ±1 switching inverters instead of analog-RF phase/magnitude controllers to help further reduce build-of-material (BoM) cost. Accordingly, the digital processing circuit 602 may be configured to perform digital precoding with cross connectivity and ±1 switching elements.

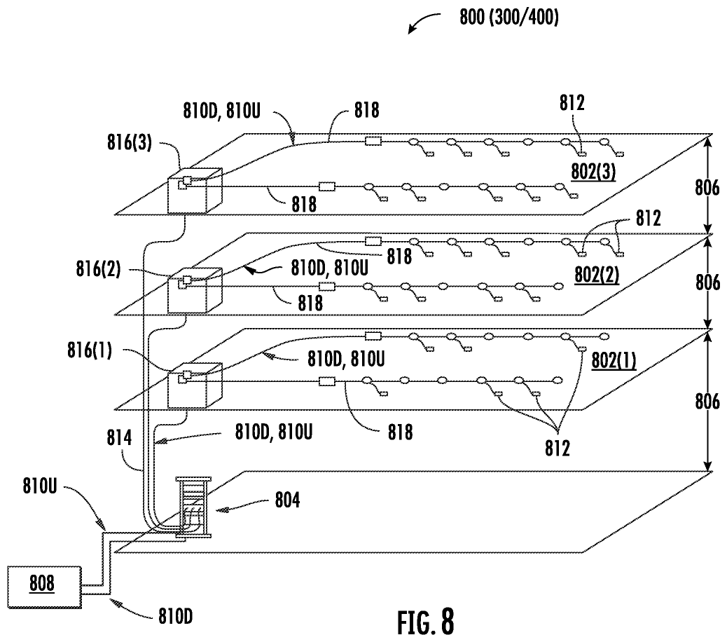

The WCS 300 of FIG. 3, which can include the beamforming system 400 in FIG. 4, can be provided in an indoor environment as illustrated in FIG. 8. FIG. 8 is a partial schematic cut-away diagram of an exemplary building infrastructure 800 in a WCS, such as the WCS 300 of FIG. 3 that includes the beamforming system 400 of FIG. 4 to support multi-data stream and multi-beam beamforming. The building infrastructure 800 in this embodiment includes a first (ground) floor 802(1), a second floor 802(2), and a third floor 802(3). The floors 802(1)-802(3) are serviced by a central unit 804 to provide antenna coverage areas 806 in the building infrastructure 800. The central unit 804 is communicatively coupled to a base station 808 to receive downlink communications signals 810D from the base station 808. The central unit 804 is communicatively coupled to a plurality of remote units 812 to distribute the downlink communications signals 810D to the remote units 812 and to receive uplink communications signals 810U from the remote units 812, as previously discussed above. The downlink communications signals 810D and the uplink communications signals 810U communicated between the central unit 804 and the remote units 812 are carried over a riser cable 814. The riser cable 814 may be routed through interconnect units (ICUs) 816(1)-816(3) dedicated to each of the floors 802(1)-802(3) that route the downlink communications signals 810D and the uplink communications signals 810U to the remote units 812 and also provide power to the remote units 812 via array cables 818.

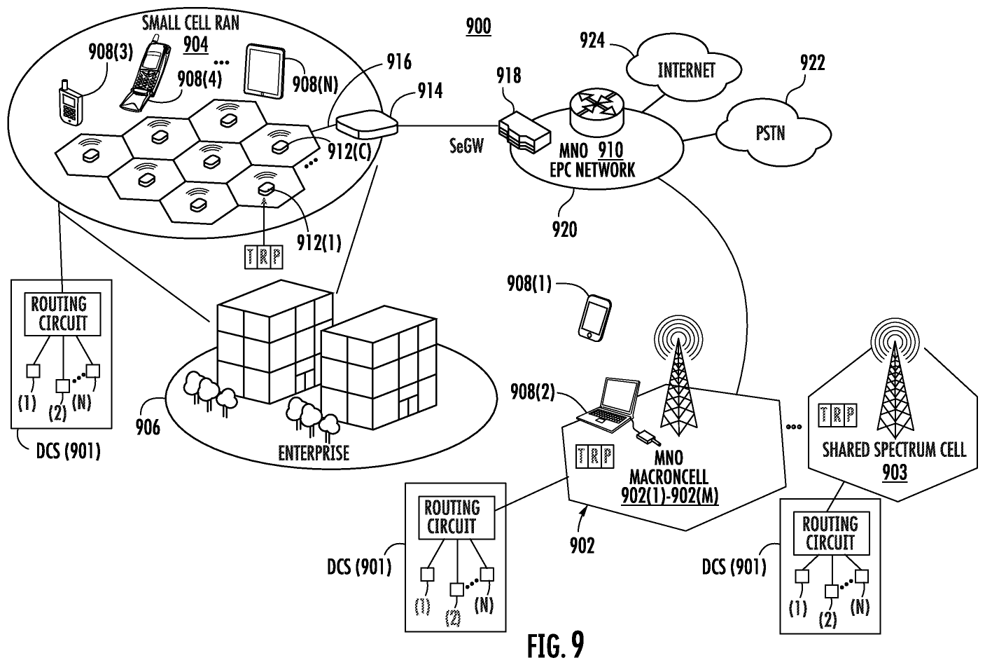

The WCS 300 of FIG. 3, which can include the beamforming system 400 of FIG. 4, configured to reduce beamforming power consumption, can also be interfaced with different types of radio nodes of service providers and/or supporting service providers, including macrocell systems, small cell systems, and remote radio heads (RRH) systems, as examples. For example, FIG. 9 is a schematic diagram of an exemplary mobile telecommunications environment 900 (also referred to as “environment 900”) that includes radio nodes and cells that may support shared spectrum, such as unlicensed spectrum, and can be interfaced to shared spectrum WCSs 901 supporting coordination of distribution of shared spectrum from multiple service providers to remote units to be distributed to subscriber devices. The shared spectrum WCSs 901 can include the WCS 300 of FIG. 3 that includes the beamforming system 400 of FIG. 4, as an example.

The environment 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to a mobile network operator (MNO) 910. A serving RAN for the user mobile communications devices 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas the user mobile communications devices 908(1) and 908(2) are being serviced by the macrocell 902. The macrocell 902 is an MNO macrocell in this example. However, a shared spectrum RAN 903 (also referred to as “shared spectrum cell 903”) includes a macrocell in this example and supports communications on frequencies that are not solely licensed to a particular MNO, such as CBRS for example, and thus may service user mobile communications devices 908(1)-908(N) independent of a particular MNO. For example, the shared spectrum cell 903 may be operated by a third party that is not an MNO and wherein the shared spectrum cell 903 supports CBRS. Also, as shown in FIG. 9, the MNO macrocell 902, the shared spectrum cell 903, and/or the small cell RAN 904 can interface with a shared spectrum WCS 901 supporting coordination of distribution of shared spectrum from multiple service providers to remote units to be distributed to subscriber devices. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO macrocell 902, the shared spectrum cell 903, and the small cell RAN 904 depending on the location of the user mobile communications devices 908(3)-908(N).

In FIG. 9, the mobile telecommunications environment 900 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 900 includes the enterprise environment 906 in which the small cell RAN 904 is implemented. The small cell RAN 904 includes a plurality of small cell radio nodes 912(1)-912(C). Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g., evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The environment 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the environment 900.

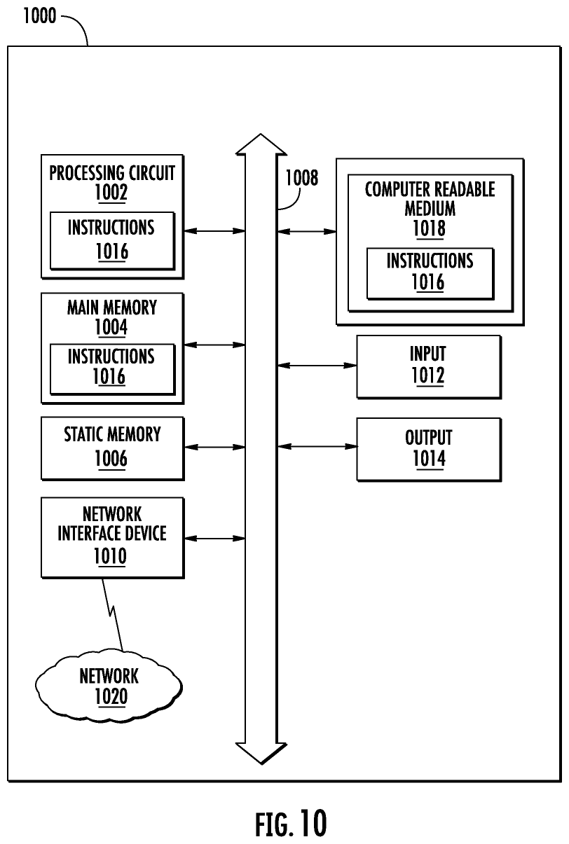

Any of the circuits in the WCS 300 of FIG. 3 and the beamforming system 400 of FIG. 4, such as the beamforming circuit 402, can include a computer system 1000, such as that shown in FIG. 10, to carry out their functions and operations. With reference to FIG. 10, the computer system 1000 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1000 in this embodiment includes a processing circuit or processor 1002, a main memory 1004 (e.g., read-only memory (ROM), flash memory, dynamic random access memory (DRAM) such as synchronous DRAM (SDRAM), etc.), and a static memory 1006 (e.g., flash memory, static random access memory (SRAM), etc.), which may communicate with each other via a data bus 1008. Alternatively, the processing circuit 1002 may be connected to the main memory 1004 and/or static memory 1006 directly or via some other connectivity means. The processing circuit 1002 may be a controller, and the main memory 1004 or static memory 1006 may be any type of memory.

The processing circuit 1002 represents one or more general-purpose processing circuits such as a microprocessor, central processing unit, or the like. More particularly, the processing circuit 1002 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1002 is configured to execute processing logic in instructions 1016 for performing the operations and steps discussed herein.

The computer system 1000 may further include a network interface device 1010. The computer system 1000 also may or may not include an input 1012 to receive input and selections to be communicated to the computer system 1000 when executing instructions. The computer system 1000 also may or may not include an output 1014, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1000 may or may not include a data storage device that includes instructions 1016 stored in a computer-readable medium 1018. The instructions 1016 may also reside, completely or at least partially, within the main memory 1004 and/or within the processing circuit 1002 during execution thereof by the computer system 1000, the main memory 1004 and the processing circuit 1002 also constituting the computer-readable medium 1018. The instructions 1016 may further be transmitted or received over a network 1020 via the network interface device 1010.

While the computer-readable medium 1018 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A beamforming system, comprising:
an antenna array comprising a plurality of antenna elements organized in a first number of rows and a second number of columns, wherein the first number of rows is greater than or equal to four rows; and
a beamforming circuit configured to:
generate at least four processed streams each comprising a pair of data streams and processed to have a respective one of at least four phases; and
provide the at least four processed streams to at least four of the first number of rows based on a predetermined feeding pattern to thereby cause the antenna array to simultaneously radiate a plurality of radio frequency (RF) beams each comprising the pair of data streams in a defined set of elevations.

2. The beamforming system of claim 1, wherein the plurality of antenna elements is separated by an antenna spacing that is less than or greater than one-half wavelength.

3. The beamforming system of claim 1, wherein the at least four processed streams are further processed to cause the antenna array to simultaneously radiate the plurality of RF beams in a defined set of azimuth angles.

4. The beamforming system of claim 1, wherein:
the plurality of antenna elements in the antenna array is organized into four rows and eight columns; and
the beamforming circuit comprises a beam processing circuit configured to:
operate in a first state to:
generate four first processed streams each comprising a first pair of data streams and processed to have a respective one of four first phases; and
provide the four first processed streams to the four rows to thereby cause the antenna array to simultaneously radiate the plurality of RF beams each comprising the first pair of data streams in a first set of elevations; and
operate in a second state to:
generate four second processed streams each comprising a second pair of data streams and processed to have a respective one of four second phases; and
provide the four second processed streams to the four rows to thereby cause the antenna array to simultaneously radiate the plurality of RF beams each comprising the second pair of data streams in a second set of elevations.

5. The beamforming system of claim 4, wherein beam processing circuit is further configured to operate in the first state and the second state based on time-division.

6. The beamforming system of claim 4, wherein:
the four first processed streams are further processed to cause the antenna array to simultaneously radiate the plurality of RF beams in a first set of azimuth angles; and
the four second processed streams are further processed to cause the antenna array to simultaneously radiate the plurality of RF beams in a second set of azimuth angles.

7. The beamforming system of claim 4, wherein:
in the first state, the beam processing circuit is further configured to:
provide a first one of the four first processed streams to a first one of the four rows in the antenna array;
provide a second one of the four first processed streams to a third one of the four rows in the antenna array;
provide a third one of the four first processed streams to a second one of the four rows in the antenna array; and
provide a fourth one of the four first processed streams to a fourth one of the four rows in the antenna array; and
in the second state, the beam processing circuit is further configured to:
provide a first one of the four second processed streams to a first one of the four rows in the antenna array;
provide a second one of the four second processed streams to a third one of the four rows in the antenna array;
provide a third one of the four second processed streams to a second one of the four rows in the antenna array; and
provide a fourth one of the four second processed streams to a fourth one of the four rows in the antenna array.

8. The beamforming system of claim 7, wherein:
in the first state:
the first one of the four first processed streams is processed to have the respective one of four first phases that equals minus one hundred eighty degrees (−180°);
the second one of the four first processed streams is processed to have the respective one of four first phases that equals zero degrees (0°);
the third one of the four first processed streams is processed to have the respective one of four first phases that equals minus ninety degrees (−90°); and
the fourth one of the four first processed streams is processed to have the respective one of four first phases that equals minus two hundred seventy degrees (−270°); and
in the second state:
the first one of the four second processed streams is processed to have the respective one of four second phases that equals plus one hundred eighty degrees (+180°);
the second one of the four second processed streams is processed to have the respective one of four second phases that equals zero degrees (0°);
the third one of the four second processed streams is processed to have the respective one of four second phases that equals zero degrees (0°); and
the fourth one of the four second processed streams is processed to have the respective one of four second phases that equals plus one hundred eighty degrees (+180°).

9. The beamforming system of claim 4, wherein the first set of elevations comprises two first elevations and the second set of elevations comprises two second elevations that are interleaved with the two first elevations.

10. A method for forming multi-data stream and multi-beam radio frequency (RF) beams in a wireless communications system (WCS), comprising:
organizing a plurality of antenna elements in an antenna array in a first number of rows and a second number of columns, wherein the first number of rows is greater than or equal to four rows;
generating at least four processed streams each comprising a pair of data streams and processed to have a respective one of at least four phases; and
providing the at least four processed streams to at least four of the first number of rows based on a predetermined feeding pattern to thereby cause the antenna array to simultaneously radiate a plurality of RF beams each comprising the pair of data streams in a defined set of elevations.

11. The method of claim 10, further comprising processing the at least four processed streams to cause the antenna array to simultaneously radiate the plurality of RF beams in a defined set of azimuth angles.

12. The method of claim 10, further comprising:
organizing the plurality of antenna elements in the antenna array into four rows and eight columns;
operating in a first state to generate four first processed streams each comprising a first pair of data streams and processed to have a respective one of four first phases;
providing the four first processed streams to the four rows to thereby cause the antenna array to simultaneously radiate the plurality of RF beams each comprising the first pair of data streams in a first set of elevations;
operating in a second state to generate four second processed streams each comprising a second pair of data streams and processed to have a respective one of four second phases; and
providing the four second processed streams to the four rows to thereby cause the antenna array to simultaneously radiate the plurality of RF beams each comprising the second pair of data streams in a second set of elevations.

13. The method of claim 12, further comprising operating the first state and the second state based on time-division.

14. The method of claim 12, further comprising:
processing the four first processed streams to cause the antenna array to simultaneously radiate the plurality of RF beams in a first set of azimuth angles; and
processing the four second processed streams to cause the antenna array to simultaneously radiate the plurality of RF beams in a second set of azimuth angles.

15. The method of claim 12, further comprising:
operating in the first state to:
provide a first one of the four first processed streams to a first one of the four rows in the antenna array;
provide a second one of the four first processed streams to a third one of the four rows in the antenna array;
provide a third one of the four first processed streams to a second one of the four rows in the antenna array; and
provide a fourth one of the four first processed streams to a fourth one of the four rows in the antenna array; and
operating in the second state to:
provide a first one of the four second processed streams to a first one of the four rows in the antenna array;
provide a second one of the four second processed streams to a third one of the four rows in the antenna array;
provide a third one of the four second processed streams to a second one of the four rows in the antenna array; and
provide a fourth one of the four second processed streams to a fourth one of the four rows in the antenna array.

16. The method of claim 15, further comprising:
in the first state:
processing the first one of the four first processed streams to have the respective one of four first phases that equals minus one hundred eighty degrees (−180°);
processing the second one of the four first processed streams to have the respective one of four first phases that equals zero degrees (0°);
processing the third one of the four first processed streams to have the respective one of four first phases that equals minus ninety degrees (−90°); and
processing the fourth one of the four first processed streams to have the respective one of four first phases that equals minus two hundred seventy degrees (−270°); and
in the second state:
processing the first one of the four second processed streams to have the respective one of four second phases that equals plus one hundred eighty degrees (+180°);
processing the second one of the four second processed streams to have the respective one of four second phases that equals zero degrees (0°);
processing the third one of the four second processed streams to have the respective one of four second phases that equals zero degrees (0°); and
processing the fourth one of the four second processed streams to have the respective one of four second phases that equals plus one hundred eighty degrees (+180°).

17. A wireless communications system (WCS), comprising:
a distribution unit configured to distribute a plurality of data signals; and
a plurality of wireless nodes coupled to the distribution unit, wherein each of the plurality of wireless nodes comprises a beamforming system that comprises:
an antenna array comprising a plurality of antenna elements organized in a first number of rows and a second number of columns, wherein the first number of rows is greater than or equal to four rows; and
a beamforming circuit configured to:
generate at least four processed streams each comprising a pair of data streams and processed to have a respective one of at least four phases; and
provide the at least four processed streams to at least four of the first number of rows based on a predetermined feeding pattern to thereby cause the antenna array to simultaneously radiate a plurality of radio frequency (RF) beams each comprising the pair of data streams in a defined set of elevations.

18. The WCS of claim 17, wherein the at least four processed streams are further processed to cause the antenna array to simultaneously radiate the plurality of RF beams in a defined set of azimuth angles.

19. The WCS of claim 17, further comprising:
a digital routing unit coupled to the distribution unit; and
a plurality of remote units coupled to the digital routing unit via a plurality of optical fiber-based communications mediums.

20. The WCS of claim 19, wherein:
the digital routing unit comprises:
an electrical-to-optical (E/O) converter configured to convert a plurality of downlink communications signals into a plurality of downlink optical communications signals, respectively; and
an optical-to-electrical (O/E) converter configured to convert a plurality of uplink optical communications signals into a plurality of uplink communications signals, respectively; and
the plurality of remote units each comprises:
a respective O/E converter configured to convert a respective one of the plurality of downlink optical communications signals into a respective one of the plurality of downlink communications signals; and
a respective E/O converter configured to convert a respective one of the plurality of uplink communications signals into a respective one of the plurality of uplink optical communications signals.
